(19) United States
(12) Patent Application Publication
(10) Pub. No.: US 2010/0070607 A1
(43) Pub. Date: Mar. 18, 2010

(54) Scalable Method for Contextual Information Updates and Notification

(75) Inventors: Furqan Khan, Alameda, CA (US); Rikard Kjellberg, Santa Cruz, CA (US)

Correspondence Address: FISH & RICHARDSON P.C., PO BOX 1022, MINNEAPOLIS, MN, 55440-1022, US

(73) Assignee: Ingboo Inc., Santa Cruz, CA (US)

(21) Appl. No.: 12/559,981

(22) Filed: Sep. 15, 2009

Related U.S. Application Data
(60) Provisional application No. 61/097,482, filed on Sep. 16, 2008.

(51) Int. Cl. G06F 15/16

(52) U.S. Cl. 709/217

(57) ABSTRACT

The disclosed implementations enable websites to deploy highly contextual, consumer-controlled, scalable, and proactive information relationship channels. Consumers can subscribe to a subset of the information relevant to them and receive information as per their individually configured preferences.

### CROSS-REFERENCE TO RELATED APPLICATION

This application claims the benefit of U.S. Provisional Application Ser. No. 61/097,482, filed on Sep. 16, 2008, the entire content of which is hereby incorporated by reference.

### TECHNICAL FIELD

The technology described herein generally relates to online content delivery.

### BACKGROUND

The Internet has emerged as a key customer relationship channel for online services. Content publishers and content retailers distribute information to individual users via blogs, personal or community webpages, company websites, newsletters, emails, and so on. Regardless of whether the content sources are managed by individuals or companies, or whether the information is the primary content for user consumption or the vehicle for promoting other product or services, one important objective of the information providers is to engage the consumers and garner their attention on a repeat basis.

To help the consumers discover an information source (e.g., a website or a newsfeed) and to attract consumer attention, an administrator of the information source typically uses various methods to get the information source listed on popular search engines. In addition, the administrator may spend marketing budgets on various forms of online advertisements, such as context-based or search-based advertisements. If consumers are able to discover and subsequently visit the information source (e.g., by downloading a webpage from a website using a web browser), it is imperative that the information source establish a continued relationship with the visiting consumers.

There are many tools available to establish and manage the continued relationships between consumers and information sources. Some examples of such tools include email alerts, newsletters, and Really Simple Syndication (RSS). Online services including content publishers and content retailers use these tools to proactively reach out to consumers with information updates, special offers, product updates, and news on a regular basis.

However, consumer adoption of these relationship tools has been dismal. Consumers tend to view these tools as creating spam and adding to the overall information clutter for the consumers.

There are several reasons for the low adoption of existing proactive relationship tools.

First, existing tools (e.g., alerts, newsletters, RSS) lack granular context for individual consumers. Instead, the tools focus on generic content that caters to a broad audience. For example, consumers are unable to opt-in to specific topics of their interests via a newsletter service. Instead, generic newsletters fill up consumer inboxes every day, where they are often disregarded and remain unread. Even if a particular content publisher offers subscription to subcategories of information, the content publisher has to create different content specifically for each of the subcategories (e.g., different newsletters) for distribution to the subscribing consumers. The burden of maintaining and distributing the different categories of content severely limits the granularity of the content that a publisher is able to provide. Consumers will still receive much content that are not of interest to them.

Second, the existing tools provide little control to consumers in terms of preventing identity abuse. Personal email addresses are often distributed and sold without consumers' permissions. As a result, consumers who signup to receive one type of content from one information source, often become targets for many SPAM mailers for unrelated and irrelevant information.

Third, the existing tools offer little control over information flow from multiple online channels. Management of delivery channels, delivery timing and format, is difficult, if not impossible.

### SUMMARY

The deficiencies in existing proactive relationship tools, such as the lack of information granularity for individual users, the lack of user privacy control, and the lack of control over multiple information channels, can be overcome by capturing and storing contextual and user control information on an individual basis. Managing, storing and processing this contextual and user control information are separated from managing and provision of information by information sources, thus enabling information sources to deploy highly contextual, consumer-controlled, scalable, and proactive relationship channels without undue and/or prohibitive resource burdens.

In one aspect, a computer-implemented content distribution method includes: receiving information from an information source; filtering, by a processor, the received information through one or more topical filters, wherein at least one of the one or more topical filters identifies one or more updates in the received information; filtering the identified information updates through one or more user-specific filters, wherein the one or more user-specific filters were configured by users that subscribe to the at least one of the one or more topical filters; and notifying a user of the identified information updates if the identified information updates satisfy the user-specific filter of the user.

In some implementations, the content distribution method further includes: receiving first user input from a user to subscribe to a first topical filter, the first user input being directed to a first context control user interface element presented on a user interface of the information source, the first context control user interface element being associated with the first topical filter; and in response to the first user input, associating the first topical filter with the user. In some implementations, the content distribution method further includes: after receiving the first user input, receiving second user input from the user to configure a first user-specific filter; and in response to the second user input, associating the first user-specific filter with the user and the user's subscription to the first topical filter.

In some implementations, the content distribution method further includes: receiving a definition of a first topical filter; and presenting a first context control user interface element on the user interface of the information source, the first context control user interface element being associated with the first topical filter.

In some implementations, at least one of the one or more user-specific filters specifies a respective relevancy parameter for selecting information updates.

In some implementations, at least one of the one or more user-specific filters specifies a respective delivery control parameter for distributing information updates.

In some implementations, the content distribution method further includes: associating a respective criticality parameter with each of identified information updates; and the action of notifying the user of the identified information updates further includes: issuing notifications to the user at times determined according to the criticality parameters associated with the identified information updates.

Computer-readable media and systems implementing various aspects of the content distribution techniques are also disclosed.

In various implementations, the disclosed techniques may offer one or more of the following advantages.

The disclosed implementations enable websites and other information sources to deploy highly contextual, consumer-controlled, scalable, and proactive information relationship channels. A website and other information sources can continue to offer generic or semi-generic content. However, consumers can subscribe to a subset of the generic and semi-generic information that is relevant to them and receive information updates according to their individually configured preferences. The implementations enable highly contextual information distribution while obviating the need for the websites and the other information sources to manage, store and process the granularity of the context and control for information distribution. An intelligent intermediary can separate the information source from the information distribution process, and filter the information updates according to individualized consumer-specified context and control.

Although the complete set of information available through the websites or other information sources is comprehensive and covers a broad range of topics, an individual consumer can subscribe to, and receive a highly targeted subset of the information on a delivery channel, schedule, and format defined by the individual consumer. Therefore, the relevancy of the information received by the individual consumer is improved.

By leveraging commonality between subscribed information channels and context controls among many users and assigning criticality to information updates, the system implementing the disclosed content distribution methods can dynamically allocate resources to various information distribution tasks. This leveraging and prioritization allow the system to scale while ensuring timely delivery of information to end users.

Details of one or more implementations of the content distribution techniques are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic of an operating environment for an example content distribution system.

FIGS. 2A and 2B are example user interface elements for context control subscription on a user interface of an information source.

FIG. 3 is a schematic illustrating an example use case for creating a context control subscription.

FIG. 4 is a schematic illustrating an example use case for filtering information updates according to context controls and user-specific controls.

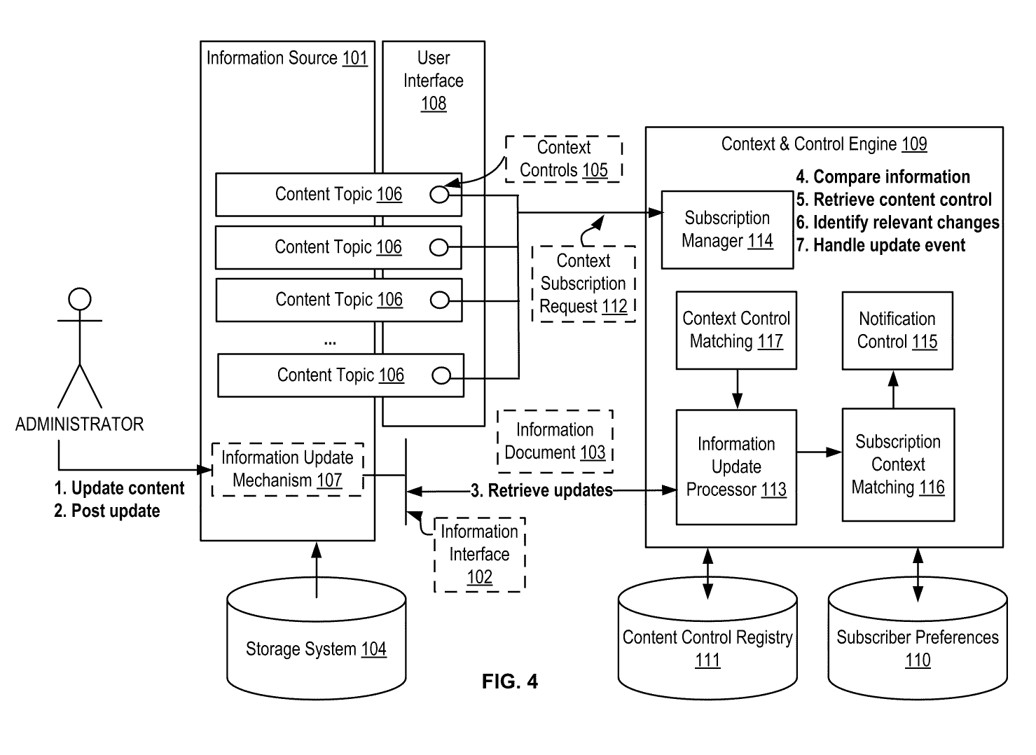

FIG. 5 is a schematic illustrating an example use case for notifying users of relevant information updates.

FIG. 6 is a flow diagram of an example content distribution process.

FIG. 7 is a block diagram of a generic computing system.

### DETAILED DESCRIPTION

This specification describes aspects of systems and methods for efficient management and distribution of information from a general information source to many subscribers over the Internet. The described systems enable subscribers who are interested in only particular subsets of the information to create user-specific controls for channels, relevance, formats, scheduling of information delivery.

### System Architecture

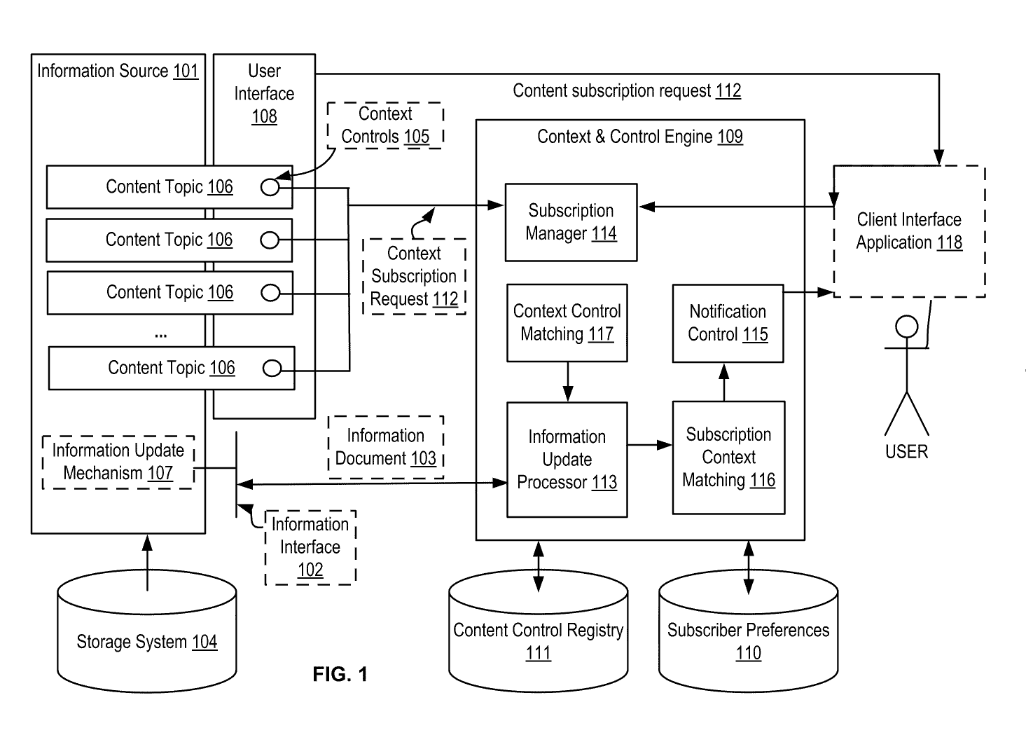

FIG. 1 is a schematic of an operating environment for an example content distribution system.

The operating environment includes an information source 101. The information source 101 provides an information interface 102 for information retrieval by another system or component in the form of an information document 103. The information source 101 is coupled to a storage system 104 which stores various content data for the information source 101. The information source 101 also provides a user interface 108 for access by a client interface application 118. The user interface 108 presents a number of context controls 105 along with the primary content of the information source 101. The context controls 105 enable user selection of various context or topical filters 106 that are associated with the context controls 105. The information source 101 also includes an information update mechanism 107 for generating information and content updates for the information source 101, e.g., in the form of an information document 103.

The operating environment also includes a context & control engine 109. The context & control engine 109 includes an information update processor 113. The information update processor 113 interacts with the information source 101 through the information interface 102 and obtains information updates in the form of information documents 103. The context & control engine 109 also includes a subscription manager 114. The subscription manager 114 receives subscription requests 112 from users and associates the users with the selected context and topical filters defined by the context controls 105. The subscription manager 114 stores context control definitions and associated user subscription information in the context control registry 111. The subscription manager 114 also stores subscriber-specific controls and filtering rules in the subscriber preferences repository 110.

The context & control engine 109 further includes a context control matching mechanism 117 and a subscription context matching mechanism 116. The context control matching mechanism 117 filters the retrieved information document 103 for information updates that are subscribed by users for the information source 101. When information updates satisfying particular subscribed context and topical filters are detected by the context matching mechanism 117, the information updates are further filtered by the subscription context matching mechanism 116. The subscription context matching mechanism 116 applies subscriber-specific filters to the information updates to generate subscriber-specific information updates. The notification control 115 of the context & control engine 109 provides subscriber-specific information updates to each subscriber through the client interface application 118.

The information source 101 is an example generic information source that implements processes and functions, such as presenting content, updating information, and providing a user interface for accessing the content and the information updates. One example embodiment of the information source 111 is a web server that is accessible via standard communication protocols, such as Transmit Control Protocol (TCP) and Hyper Text Transfer Protocol (HTTP). The web server stores webpages and related information resources in the storage system 104. In response to an HTTP request from a web client, the web server provides a response serving the requested webpage and/or information resources to the requesting web client. Information source 101 is not limited to the embodiments disclosed herein. Other embodiments such as news servers, email servers, and instant messaging servers, which use standard technologies and protocols for an information source, are within the scope of this disclosure.

The information source 101 provides an information interface 102 that can be accessed by an external component or system for information retrieval purposes. This interface may be secure (e.g., requiring password and encrypting data) or non-secure. A non-secure embodiment of the information interface 102 can accept an HTTP GET request to pull an information document from the information source 101. A secure embodiment of the information interface 102 can use HTTPS or Secure Socket Layer (SSL) to encrypt the data sent to and from the information source 101. Examples of the information interface 102, based on HTTP or HTTPS, include RSS feeds and Simple Object Access Protocol (SOAP). Information can be retrieved by a client system issuing an HTTP GET request to the URL of the information source 101 and by the client system parsing the data that is received from the information source 101.

In some implementations, the information interface 102 utilizes a push-based technique rather than pull-based technique for information delivery. With a push-based information delivery scheme, the information source 101 will push information updates to an external subscriber system according to a predefined schedule or as changes in the information occur. According to the push-based information delivery scheme, the external subscriber system does not need to proactively send requests for information updates to the information source 101 in order to obtain the information updates. One example of a push-based protocol is an asynchronous event/messaging service (e.g., JMS, Tibco Bus).

Information that is delivered via the information interface 102 can be structured and stored in an information document 103. In one embodiment, the information document 103 is written in eXtensible Markup Language (XML), a standard format that is easily parsed and analyzed. Both RSS and SOAP make use of XML for information delivery. In another embodiment, the information document 103 is in a Resource Description Framework (RDF) format. The information document 103 is not limited to the embodiments here disclosed. Other embodiments comprising standard technologies and protocols for information delivery are within the scope of this disclosure.

In some implementations, the information source 101 maintains its information in a persistent storage, such as the storage system 104. If the information source 101 is a web server, the storage system 104 can be a combination of static Hyper Text Markup Language (HTML) pages and dynamic data managed by a database management system, such as a Relational Database Management System (RDBMS). The storage system 104 can use other storage technologies as well.

The information source 101 can include an information update mechanism 107. When an information update becomes available, the information update is published to the information interface 102. The publication of the latest updates and the scheduling of update publications can be managed within the information source 101 by the information update mechanism 107. The information update mechanism 107 can be implemented as a manual process or as a fully automated process. FIG. 1 illustrates that information updates can be stored in the storage system 104 and managed by, for example, a relational database management system (RDBMS). The information update mechanism 107 can retrieve the information updates from the storage system 104, creates an information document 103, and then publish the created information document 103 to the information interface 102. The information update processor 113 of the context and control engine 109 retrieves the information document 103 through the information interface 102 for further processing.

Alternative to the information update mechanism 117, the context & control engine 109 can perform the publication of the latest updates and the scheduling of update publications. For example, the context & control engine 109 can analyze the content at the information source 101 according to one or more context control definitions specified by the context control matching mechanism 117 and according to a configurable schedule. This schedule can be defined by a time interval, by other external events, or other suitable methods for the context & control engine 109. The context & control engine 109 then generates the information document 103 and passes the information document 103 to the information update processor 113.

The example context and control engine 109 shown in FIG. 1 includes the subscription manager 114, the context control matching mechanism 117, the information update processor 113, the subscription context matching mechanism 116, and the notification control 115. The context & control engine 109 also communicates with secondary storage: the context control registry 111 and the subscriber preferences repository 110. While the context & control engine 109 can be viewed as one logical unit, a scalable implementation may require segmentation and replication of the context & control engine's functionalities across multiple hardware processors.

The context & control engine 109 can interact with the information source 101 via the information interface 102 and the context controls 105 that are presented on the user interface 102.

The user interface 108 of the information source 101 is accessible by a client interface application 118. One embodiment of the user interface 108 can be an HTML page accessible via an internet browser application, commonly available on most internet-enabled devices. The HTML page can include content in the form of text, images, links, video clips, sound files, and so on. The HTML page can also include dynamic and programmable elements, such as scripts. The user interface 108 can further include user interface elements that can accept user input for various purposes, e.g., submission of user login information, selection of options, and so on. Other content presentation interfaces are within the scope of this disclosure.

The user interface 108 can provide user access to the context controls 105. For example, each available context control 105 can be associated with a respective user interface elements presented on the user interface 108. When a user subscribes to a particular context control 105 by selecting the corresponding user interface element on the user interface 108, a context subscription request 112 is generated by the selected context control 105 on the user interface 108 and sent to the context & control engine 109. When the user makes a content subscription request 112 via a context control 105, additional input can be requested through the user interface 108. Examples of such additional input can include username and password (for secure content). Other additional input can be requested through the user interface 108 or additional user interfaces (e.g., a pop up window or editable web form) invoked through the user interface 108. In some implementations, the additional input may also include user preferences for content delivery format, schedule, and additional user-specific filtering rules.

Although the user can invoke the context controls 105 while visiting the information source 101 through the user interface 108, the collection of user selection of context controls and additional input is performed by the subscription manager 114 of the context & control engine 109. For example, the user interface elements associated with the context controls can be further associated with an executable script. When a user interface element is selected by a user, the script is executed either locally on the client device used by the user or remotely at the context & control engine 109. The script can invoke a process in the subscription manager 114 to create and store the association between the user and the selected context control.

Content at the information source 101 is typically organized according to content topics 106. Examples of content topics include “Cameras,” “DVD Players,” “Laptop Computers,” “price points,” “calendar events,” and so on. Depending on the nature of the information source, the topics will vary. Topics of an information source can be broad (e.g., “Electronics”) or very narrow (e.g., “Canon Digital Cameras”). Topics can be defined using any structure or methodology, either by the information source or by the context & control engine. For example, topics can be identified and defined using keyword search. Content topics of the information source can also be identified using various information categorization methods.

The context control 105 is a mechanism that a user can invoke to indicate the user's interest in updates to a specific content topic 106. The context control 105 can communicate with the subscription manager 114 to submit context subscription requests 112 from the user. Alternatively, the subscription requests 112 can be sent from the client interface application 118. Each context control 105 can be used to extract specific information from the information document 103 that is related to the particular content topic 106 associated with the context control 105. Furthermore, each context control 105 can also provide a way to define rules for identifying changes to the particular content topic in the information document 103.

The context control 105 can include one or more keywords, text patterns, information snippets, and/or tags that can be used to identify changes in the information document 103. For example, if a subscribed context control 105 includes a keyword, the information update processor 113 scans the information document 103 for the keyword and compares portions of the information document associated with the keyword with a previous version of the information document to determine if any updates have been made to the information document. If a change is identified according to the context control 105, the context & control engine 109 is informed of the change. Each context control 105 can also be associated with respective delivery control information, which can be user-defined and can specify delivery schedule, channel, format, priority, and other distribution control attributes.

Users can subscribe to information that is funneled or filtered through the context controls 105. Any time a user selects a context control 105 on the user interface 108, the user becomes a subscriber of that context control. A relationship (in the form of a subscription) between the user and the selected context control is established by the subscription manager 114. This relationship is registered in the subscriber preferences repository 110 and/or the context control registry 111, which may be stored in persistent storage such as a database.

Subscriber-specific attributes can be associated with each subscription. Such attributes can be used to filter a general information update for a content topic associated with a subscribed context control for additional subscriber-specific context. A subscriber may enter filtering keywords that would be applied by the subscription context matching mechanism 116 to validate that the subscriber is interested in the information update.

There can also be other subscriber-specific context details, such as usernames, passwords, account details, and so on. Such subscriber-specific context details can be stored in the subscriber preferences repository 110 and can be used by the information update processor 113 to process the information document 103 for a particular subscriber. For example, if a particular context control 105 filters for updates on bank account activities. The subscriber-specific context details can include login details for the subscriber. The information update processor 113 can use the particular context control 105 with the login details (as well as other account details and secure connectivity attributes) to gain access to the information source 101 and fetch subscriber-specific data.

Context controls 105 can be registered and managed in the context control registry 111. Each context control 105 is defined so that it can identify any change in the information document 103 that is related to the content topic 106 associated with the content control 105. The changes can include, but not be limited to, textual changes, numerical changes, changes to specific areas in the content, or a time-bound update trigger. Additional information or attributes about each context control 105 can be stored in the context control registry 111 as well. The additional information or attributes can include, but not be limited to, description of the control, creator of the control (e.g., company name or administrator name), and category of the control. In order to provide an efficient means to search and browse the content control registry 111, the context controls 105 can be organized in categories and sub-categories. The category hierarchy can vary and is subject to various implementations. Creators of a context control 105 can propose a new category for the context control or select an existing category for the context control. An administrator of the context & control engine 119 can ultimately determine and/or approve the proposed category for each newly created context control.

Users who visit the information source 111 and subscribe to various content topics 106 by invoking the corresponding context controls 105 are registered in the subscriber preferences repository 110. Subscriber preferences can include, but not be limited to, subscriber identity and the context control 105 subscribed to. The Context control registry 111 can include, but not be limited to definitions of context controls 105 and the identities of subscribers for each context control 105.

While each context control 115 is located at the information source 101 (e.g., presented on the user interface 108), the processing of context control is done by the context & control engine 109. Every time that the information update mechanism 107 of the information source 101 indicates that an update is available, the information update processor 113 of the context & control engine 109 retrieves and parses the information document 103. The information update processor 113 then sends the parsed information document 103 to the context control matching mechanism 117 to be filtered by each context control 105 that is defined for the information source 111. If a change is detected by the context control matching mechanism 117, an event is generated to the subscription context matching mechanism 116. The subscription context matching mechanism 116 then filters the detected change according to the subscribe-specific context and rules associated with subscribers of the context controls for which the changes have been detected.

The content distribution system described herein scales well by retrieving one copy of the information document 103 for multiple context controls 105 associated with the information source 101. Although multiple subscribers can subscribe to the same context control 105, information updates for each context control 105 only needs to be processed once. In addition, the system can optimize processing of information updates for duplicate context controls 105. For duplicate context controls 105, only one context control 105 needs to be processed. The system can also prioritize processing of information updates from information source 111 according to an order determined according to a criticality parameter specified in each context control 115.

The subscription manager 114 manages users' subscriptions to context controls. The subscription manager 114 can receive context subscription request 112 from the information source 111 or from the client interface application 118 when the user selects a context control 105 on the user interface 108. A user can also search the context control registry 111 directly in order to discover and subscribe to context controls 105. For each subscription, the subscription manager 114 can register an association between the subscribed context control 105 and the subscriber in the context control registry 111 and/or subscriber preferences repository 110. The subscription manager 114 can also allow users to specify additional subscriber-specific filters and rules that can be used by the information update processor 113 to extract subscriber-specific information updates. The subscription manager 114 can also receive input from the user specifying user-specific attributes for each subscribed context control. The user-specific attributes can be used by the information update processor 113 to access the information source 101 for subscriber-specific data. Examples of such subscriber-specific attributes include, for example, user-name and password to access secure content at the information source 101.

After the information update processor 113 parses an information document 103, it passes control to the context control matching mechanism 117 for further processing. The context control matching mechanism 117 matches each context control 105 associated with the information source 101 with the parsed information document 103. Based on the rules associated with each individual context control 105, the context control matching mechanism 117 will determine if a change has occurred in the content associated with each context control and notify the information update processor 113 of any detected changes.

The context & control engine 109 allows individual users to set additional context criteria (e.g., keywords, match patterns, calendar events) to further refining the relevancy of the information updates. The additional context criteria can be stored as subscriber-specific filters and rules in the subscriber preferences repository 110. The subscription context matching mechanism 116 applies the subscriber preferences 110 to further filter information updates detected by the context control matching mechanism 117. In addition, the information is filtered according to the delivery control parameters associated with the context controls 105. The delivery control parameters include, for example, delivery priority, schedule, channel, and format. Subsequently, the information update is sent to the notification control 115 for notification to the subscriber.

The notification control 115 is responsible for information distribution management via multiple channels, including web, mobile web, email, mobile SMS, etc. Each information update is assigned a criticality parameter, giving the system an indication of how time-sensitive the information update is to the subscriber. Some information updates can be distributed on a best-effort basis. Some information updates may need to be distributed immediately. By recognizing and adhering to the criticality of an information update, the system can scale better. For example, the distribution list is sorted based on a criticality parameter, ensuring that the most time-sensitive information updates are distributed before any other information updates. Before issuing a distribution request to an external notification system (e.g., email server), the notification control 115 can also consult the subscriber preferences 110 for a subscriber-specific notification schedule, if the schedule is available.

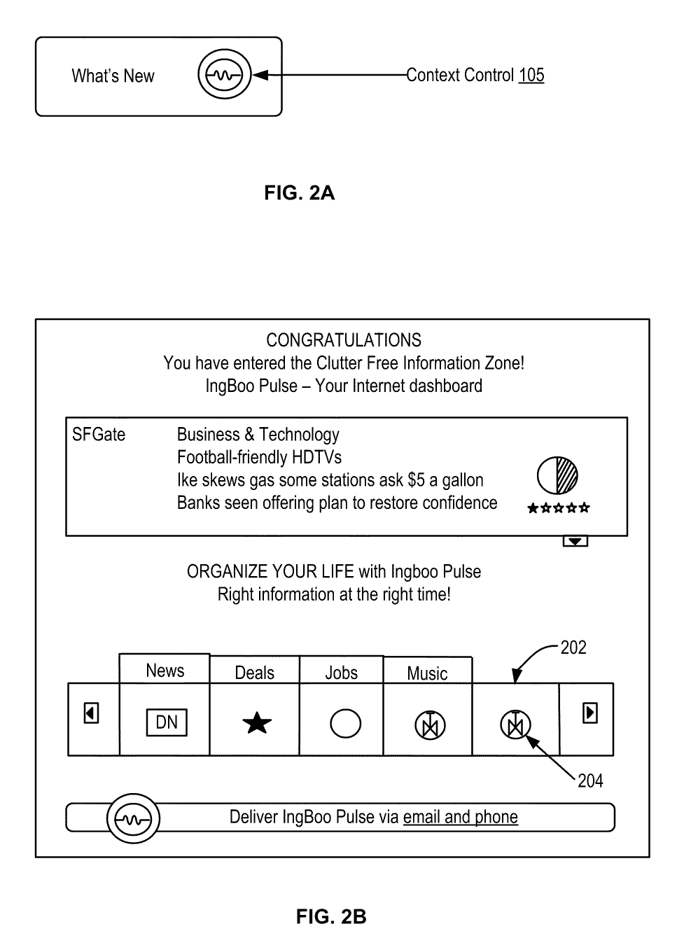

FIGS. 2A and 2B illustrate example user interface elements for the context controls on the user interface 108. A user interacting with the information source 101 via the user interface 108 is able to see the deployed context control 105 (e.g., as shown in FIG. 2A) via the client interface application (118). The user interface element for each context control can be implemented as a selectable button indicating a corresponding content topic for the content shown on the user interface 108. When the user selects a context control 105 by selecting the user interface element on the user interface 108, a content subscription request 112 can be sent to the context & control engine 109. The content subscription request notifies the context & control engine 109 that the user wishes to subscribe to information updates that satisfy the requirements or filtering criteria specified by the selected context control 105. The context & control engine 109 registers the user selection of a context control as the user's subscription to the selected context control 105. The subscription is stored in the subscriber preferences repository 110 for the content topic 106 associated with the subscribed context control 105.

FIG. 2B shows an example interface that contains a confirmation of the subscription. FIG. 2B also presents an example list 202 of information sources under different categories such as “news,” “deals,” “jobs,” “entertainment,” “sports,” and so on. Each information source can be represented by a selectable user interface element, such as a button 204. When the user selects one of the user interface element for an information source, the user can enter keywords and/or rules to define a user-specific context control to track the changes on the selected information source.

### Use Cases

### Use Case #1—User Subscribing to a Content Topic

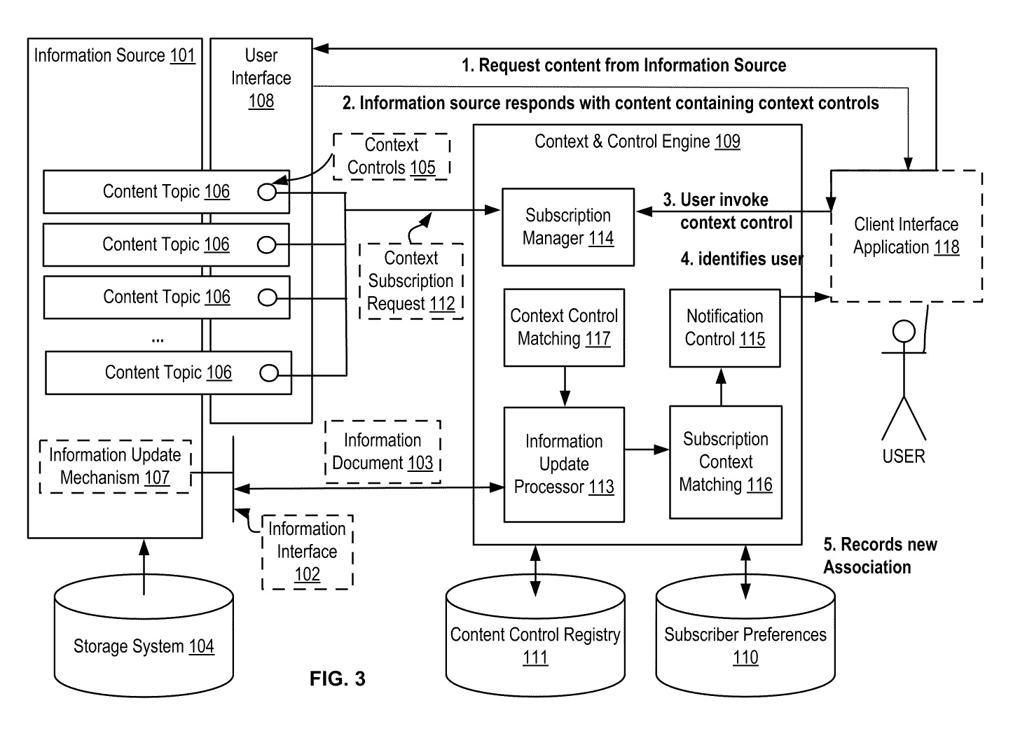

FIG. 3 is a schematic illustrating an example use case for creating a context control subscription.

In this example, a user visits an information source 101, such as a website by making a request for content using a client interface application 118. In an example embodiment, the user uses a web browser to enter a URL and retrieve content in the form of an HTML page.

In response to the user's request for content, the information source 101 sends content according to the user's request. The content includes primary content information as well as user interface elements for one or more context controls 105. In an example embodiment, the user receives the HTML page the user has requested, and the HTML page includes the primary content that the user requested, as well as context controls associated with one or more content topics. For example, on a webpage of an online computer store, the user may find context controls associated with “laptop computer deals,” “driver updates,” “deals” and so on. If the user finds a specific topic of interest, for example “laptop computers deals,” the user can select the embedded context control on the webpage for “laptop computer deals” to track future information updates related to the topic “laptop computer deals.”

Once the user invokes the context control 105 (e.g., by moving the mouse over the context control button or link and clicking on it), this action triggers a subscription request being sent to the subscription manager 114 of the context & control engine 109. The context & control engine 109 receives the user's subscription request, and starts registering the user's subscription request.

First, the subscription manager 114 identifies the user, for example, by the login information currently stored in the client interface application 118. The subscription manager 114 can also prompt the user to enter his/her login information, or request the user to set up an account first.

Then, the subscription manager 114 records a new association between the identified user and the context control 115 in the subscriber preferences repository 110 and/or the context control registry 111.

Optionally, a user interface can be presented by the subscription manager for the user to further define or customize the context control 105. For example, the user may enter additional keywords “Dell Tablet” to set up a subscriber-specific filter.

After the subscription has been set up, the context & control engine 109 can pass control back to the information source 101.

### Use Case #2—Identifying Contextual Information Change

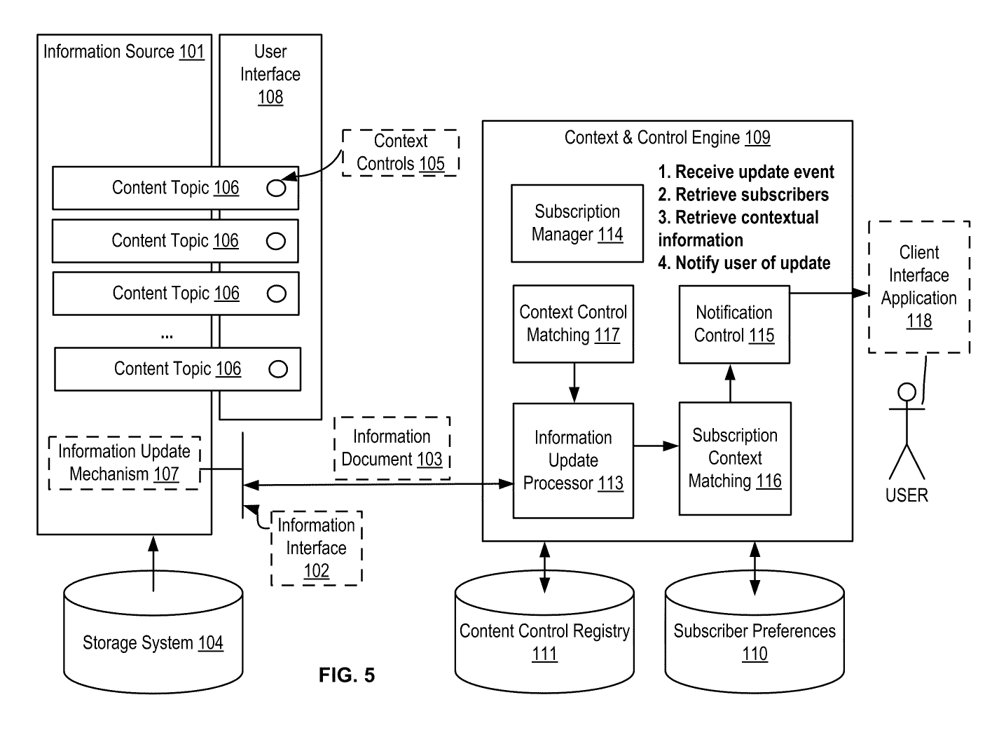

FIG. 5 is a schematic illustrating an example use case for notifying users of relevant information updates.

An administrator of the information source 101 can updates the information source 101 in various manners. For example, the administrator can update the information source by changing the information stored in the storage system 104. The updating can be performed directly on the data in the storage system 104 or via some other tool, such as the information update mechanism 107. In an example embodiment, the information source can be a website of an online computer store, and the administrator of the website can manually update the inventor data (e.g., listing of items and prices) in the storage system, or the updating can be done automatically by some software programs according to various trigging conditions (e.g., season change, inventory quantity change, etc.).

After making the changes, the administrator can manually perform an information update by posting a complete update to the information interface 102 directly or via the information update mechanism 107. For example, the administrator can manually post the changes to the webpages of the online store, or the changes are automatically posted to the information interface 102 by some software programs.

In some implementations, the information update is pushed to the context & control engine 109 in the form of an information document 103 without a specific request from the context & control engine 109. The information update processor 113 receives and processes the received information document 103. In some implementations, the information update processor 113 of the context & control engine 109 performs a scheduled retrieval of the information document 103 from the information source 101.

By comparing the information in information document 103 against earlier versions of the information documents (e.g., by comparing time-stamps and content), the information update processor 113 determines whether the information has indeed changed. In some implementations, the information source 101 may provide only the updates to the information in the information document 103, rather than the complete set of information.

After parsing the information in the information document 103, the information update processor 113 retrieves all context controls 105 associated with the information source 101 from the context control registry 111. Each of the context control 105 defines a context filtering criteria, for example, for specific topics, keywords, text patterns, schedules, and so on.

The information document 103 is filtered through each context control 105 to identify in the information document 103 a relevant change satisfying the filtering criteria specified in the context control 105.

When a change is identified, information update processor 113 sends an event to the subscription context matching mechanism 116. The information update processor 113 proceeds to process the next context control 105 for the information source 101 until all context controls associated with the information source 101 are processed. The processing of context controls and the subscription level processing can be performed in parallel. The processing of different context controls can also be performed in parallel. The system scales well because only one copy of the information document needs to be processed, and the processing of each context control only needs to be performed once for all subscribers of the context control.

### Use Case #3—Subscription Level Filtering of Contextual Information Change

FIG. 5 is a schematic illustrating an example use case for notifying users of relevant information updates.

When the information update processor 113 detects an information update related to a content topic associated with a context control, the information update processor sends an event to the subscription context matching mechanism 116. The subscription context matching mechanism 116 receives the event from the information update processor 113 with a unique identifier for the context control 105 for which the information update has been detected.

The subscription context matching mechanism 116 retrieves a list of all users who subscribe to the context control 105 for which the information update has been detected. The list of all users can be stored with the context control in the context control registry 111 or in the subscriber preferences repository 110.

The subscription context matching mechanism 116 goes through each subscriber in the list, and if a user has any subscriber-specific filters set up, the subscription context matching mechanism 116 retrieves the detected contextual information update and passes it through the subscriber-specific filters.

If the subscriber-specific filter indicates that the information update is relevant to the subscriber, the information update is propagated to the notification control 115 for subsequent delivery to the user. The notification control 115 can obtain various delivery control parameters, such as delivery priority, format, schedule, and so on, and deliver the relevant information updates to the user accordingly.

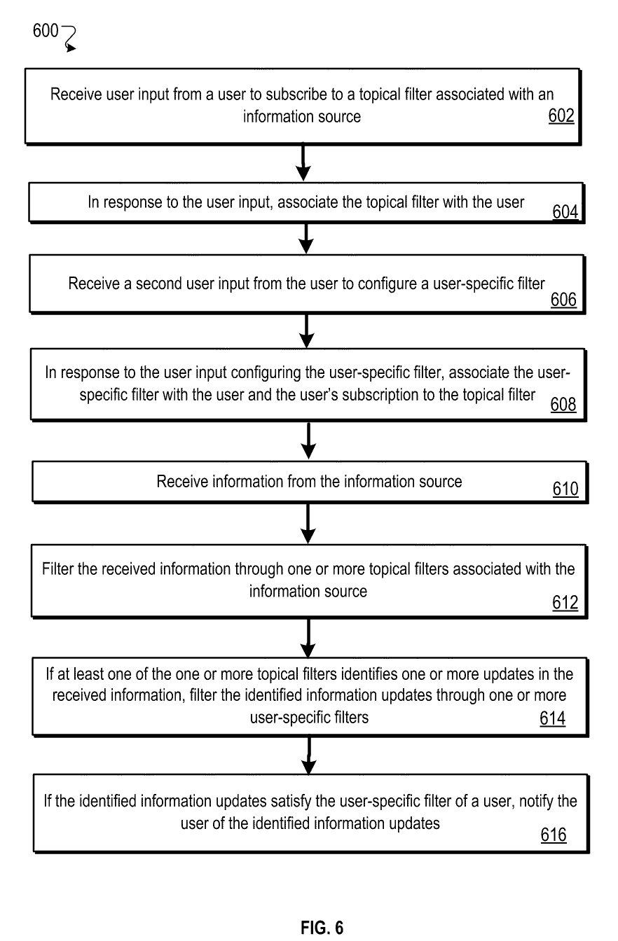

FIG. 6 is a flow diagram of an example content distribution process 600. The process 600 can be implemented by the context & control engine 109.

The process begins when the definition of a topical filter associated with an information source is received, and a context control user interface element is presented on the user interface of the information source. The topical filter is defined by a context control for a particular content topic and the context control user interface element is associated with the topical filter. User input is received from a user to subscribe to the topical filter associated with the information source (602). The user input is directed to the context control user interface element presented on the user interface of the information source. In response to the user input, the topical filter is associated with the user (604). The association can be performed by the subscription manager 114 of the context control engine 109, for example. The association can be stored as a subscription by the user to the context control in the context control registry 111 and/or the subscriber preferences repository 110.

After the user input for subscribing to the topical filter is received, a second user input is received from the user to configure a user-specific filter (606). The user-specific filter can be defined by one or more relevancy parameters for selecting information updates, such as keywords, text patterns, schedules, content type, and so on. The user-specific filter can also be defined in terms of rules to determine relevancy of information updates. In response to the user input configuring the user-specific filter, the user-specific filter is associated with the user and the user's subscription to the topical filter (608). In some implementations, one or more of the user-specific filters also specify a respective delivery control parameter for distributing information updates. The delivery control parameter can specify the delivery priority, schedule, format, and channel for the information update notification and delivery.

After the setup of topical filters and user-specific filters for a user, the process for detecting relevant information updates can start. First, information is received from the information source (610). The information can be received in the form of an information document. The received information is filtered through one or more topical filters associated with the information source (612). If at least one of the one or more topical filters identifies one or more updates in the received information, then the process continues for subscription level filtering. The topical filter for which updates have been identified is potentially associated with multiple subscribers. The identified information updates are filtered through one or more user-specific filters (614). The one or more user-specific filters have been configured by users that subscribe to the topical filters for which information updates have been identified. If the identified information updates satisfy the user-specific filter of a user, the user is notified of the identified information updates (616). No information update would be sent to the user if the identified information updates does not pass the user-specific filters for the user.

In some implementations, each of the identified information update is associated with a respective criticality parameter. The criticality parameter indicates the time-sensitivity of the information update. When notifying the user of the identified information updates, the notification is issued to the user at times determined according to the criticality parameters associated with the identified information updates.

By separating the information source from the information processing for the purpose of identifying and distributing contextual information updates, constant time scalability (O(1)) can be achieved irrespective of the number of content topics associated with the information source. The granularity of information update can be improved without undue burden on the provider of the information source. This allows for cost-effective deployment of web services where system sizing is unaffected by how granular the information context is.

Furthermore, the administrator of the information source can focus on managing one information stream and still provide highly contextual updates to its subscribers via the context controls. Each context control can be viewed as a separate information channel, independent of other information channels.

For an administrator of the information source, the management task is simplified because only one main information stream needs to be maintained, rather than multiple streams. Highly contextual information can be provided without the burden to prepare separate information streams. Administrative burden remains low on the administrator of the information source even as the number of contextual subscriptions (i.e., context controls) increases.

For an individual user (e.g., a subscriber), information filtering is performed by the context controls. The individual user does not have to manually or mentally process the entire stream of information form the information source in order to extract the updates that is of interest or relevance to the user.

The context controls are presented on the same interface as the information content presented on the user interface of the information source, making the association between context control and its corresponding content topic more intuitive to the subscribing users. The information filtering is performed by a device and application independent intermediary, and the information update filtering is transparent to the user. Multiple levels of subscriber-specific filtering are possible.

### Technical Embodiments

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

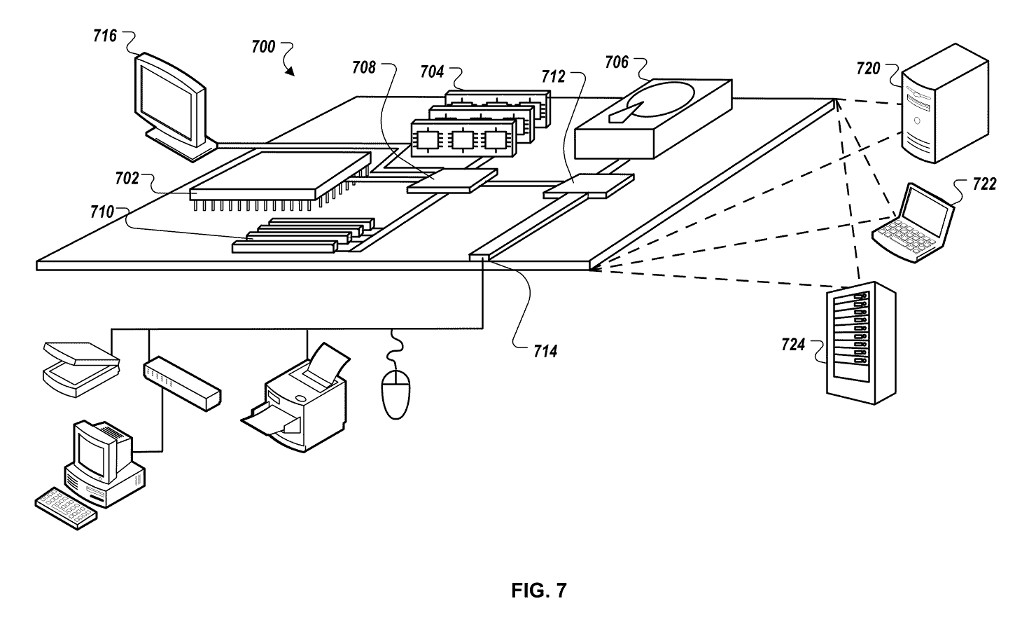

FIG. 7 is a block diagram of computing system 700 that may be used to implement the systems and methods described in this document. System 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing system 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the system 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing systems 700 may be connected, with each device providing portions of the necessary operations (e.g., as a server bank, a group of blade servers, or a multi-processor system).

The memory 704 stores information within the computing system 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing system 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing system 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing system 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722 or a mobile device (not shown). Alternatively, components from computing system 700 may be combined with other components in a mobile device (not shown). Each of such devices may contain one or more of computing systems 1000, and an entire system may be made up of multiple computing systems communicating with each other.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving information from an information source;
filtering, by a processor, the received information through one or more topical filters, wherein at least one of the one or more topical filters identifies one or more updates in the received information;
filtering the identified information updates through one or more user-specific filters, wherein the one or more user-specific filters were configured by users that subscribe to the at least one of the one or more topical filters; and
notifying a user of the identified information updates if the identified information updates satisfy the user-specific filter of the user.

2. The method of claim 1, further comprising:
receiving first user input from a user to subscribe to a first topical filter, the first user input being directed to a first context control user interface element presented on a user interface of the information source, the first context control user interface element being associated with the first topical filter; and
in response to the first user input, associating the first topical filter with the user.

3. The method of claim 2, further comprising:
after receiving the first user input, receiving second user input from the user to configure a first user-specific filter; and
in response to the second user input, associating the first user-specific filter with the user and the user's subscription to the first topical filter.

4. The method of claim 1, further comprising:
receiving a definition of a first topical filter; and
presenting a first context control user interface element on the user interface of the information source, the first context control user interface element being associated with the first topical filter.

5. The method of claim 1, wherein at least one of the one or more user-specific filters specifies a respective relevancy parameter for selecting information updates.

6. The method of claim 1, wherein at least one of the one or more user-specific filters specifies a respective delivery control parameter for distributing information updates.

7. The method of claim 1, further comprising:
associating a respective criticality parameter with each of identified information updates; and wherein:
notifying the user of the identified information updates further comprises:
issuing notifications to the user at times determined according to the criticality parameters associated with the identified information updates.

8. A computer-readable medium having instructions stored thereon, which, when executed by at least one processor, cause the processor to perform operations comprising:
receiving information from an information source;
filtering the received information through one or more topical filters, wherein at least one of the one or more topical filters identifies one or more updates in the received information;
filtering the identified information updates through one or more user-specific filters, wherein the one or more user-specific filters were configured by users that subscribe to the at least one of the one or more topical filters; and
notifying a user of the identified information updates if the identified information updates satisfy the user-specific filter of the user.

9. The computer-readable medium of claim 8, wherein the operations further comprise:
receiving first user input from a user to subscribe to a first topical filter, the first user input being directed to a first context control user interface element presented on a user interface of the information source, the first context control user interface element being associated with the first topical filter; and
in response to the first user input, associating the first topical filter with the user.

10. The computer-readable medium of claim 9, wherein the operations further comprise:
after receiving the first user input, receiving second user input from the user to configure a first user-specific filter; and
in response to the second user input, associating the first user-specific filter with the user and the user's subscription to the first topical filter.

11. The computer-readable medium of claim 8, wherein the operations further comprise:
receiving a definition of a first topical filter; and
presenting a first context control user interface element on the user interface of the information source, the first context control user interface element being associated with the first topical filter.

12. The computer-readable medium of claim 8, wherein at least one of the one or more user-specific filters specifies a respective relevancy parameter for selecting information updates.

13. The computer-readable medium of claim 8, wherein at least one of the one or more user-specific filters specifies a respective delivery control parameter for distributing information updates.

14. The computer-readable medium of claim 8, wherein the operations further comprise:
associating a respective criticality parameter with each of identified information updates; and wherein:
notifying the user of the identified information updates further comprises:
issuing notifications to the user at times determined according to the criticality parameters associated with the identified information updates.

15. A system comprising:
one or more processors;
memory coupled to the one or more processors and operable for storing instructions, which, when executed by the one or more processors, cause the one or more processors to perform operations, comprising:
receiving information from an information source;
filtering the received information through one or more topical filters, wherein at least one of the one or more topical filters identifies one or more updates in the received information;
filtering the identified information updates through one or more user-specific filters, wherein the one or more user-specific filters were configured by users that subscribe to the at least one of the one or more topical filters; and
notifying a user of the identified information updates if the identified information updates satisfy the user-specific filter of the user.

16. The system of claim 15, wherein the operations further comprise:
receiving first user input from a user to subscribe to a first topical filter, the first user input being directed to a first context control user interface element presented on a user interface of the information source, the first context control user interface element being associated with the first topical filter; and
in response to the first user input, associating the first topical filter with the user.

17. The system of claim 16, wherein the operations further comprise:
after receiving the first user input, receiving second user input from the user to configure a first user-specific filter; and
in response to the second user input, associating the first user-specific filter with the user and the user's subscription to the first topical filter.

18. The system of claim 15, wherein the operations further comprise:
receiving a definition of a first topical filter; and
presenting a first context control user interface element on the user interface of the information source, the first context control user interface element being associated with the first topical filter.

19. The system of claim 15, wherein at least one of the one or more user-specific filters specifies a respective relevancy parameter for selecting information updates.

20. The system of claim 15, wherein at least one of the one or more user-specific filters specifies a respective delivery control parameter for distributing information updates.

21. The system of claim 15, wherein the operations further comprise:
associating a respective criticality parameter with each of identified information updates; and wherein:
notifying the user of the identified information updates further comprises:
issuing notifications to the user at times determined according to the criticality parameters associated with the identified information updates.
